(19) United States
(12) Patent Application Publication
(10) Pub. No.: US 2012/0065784 A1
(43) Pub. Date: Mar. 15, 2012

(54) PROVIDING KINETIC FEEDBACK FOR COMPUTER-HUMAN INTERACTION IN VIRTUAL OR REMOTE OPERATION ENVIRONMENTS

(76) Inventor: Philip Feldman, Catonsville, MD (US)

(21) Appl. No.: 13/230,233

(22) Filed: Sep. 12, 2011

Related U.S. Application Data
(60) Provisional application No. 61/382,248, filed on Sep. 13, 2010.

(51) Int. Cl. G05D 15/01; G05D 19/02

(52) U.S. Cl. 700/280; 700/275; 700/286

(57) ABSTRACT

A kinetic feedback system for facilitating computer-human interaction includes a control member configured to be manipulated by a user, a sensor coupled with the control member, where the sensor is configured to measure a force applied to the control member due to a manipulation by the user upon the control member, an actuator configured to displace a portion of the system that is engaged by the user during system operation, and a processor coupled with the sensor and the actuator. The processor is configured with control process logic to receive signals from the sensor including information relating to forces applied to the control member by the user as measured by the sensor, control movement of an object within an environment based upon the measured forces applied to the control member by the user, and control the actuator to displace the portion of the system in response to a determination by the processor of a force being applied to the object by another object within the environment.

### CROSS REFERENCE TO RELATED APPLICATION

The present application claims priority from U.S. Provisional Patent Application Ser. No. 61/382,248, entitled “Kinetic Feedback System and Method for Computer-Human Interaction” and filed Sep. 13, 2010, the disclosure of which is incorporated herein by reference in its entirety.

### BACKGROUND

1. Field of the Invention

The present invention embodiments pertain to human-computer interfaces, particularly with respect to interactions with virtual environments and to operation of remote devices.

2. Discussion of the Related Art

Devices are known which utilize force input for control in a physical system or a computer simulated environment. For example, early-generation F-16 fighter jets utilized a rigid force sensing joystick to effect control of the jets. In addition, isometric joysticks for computer systems are known that sense applied forces to the joystick and utilize such applied forces to effect manipulation of a pointer, cursor, icon or some other marker within a running software application of the computer system.

### SUMMARY

In accordance with an example embodiment of the present invention, a kinetic feedback system for facilitating computer-human interaction comprises a control member configured to be manipulated by a user, a sensor coupled with the control member, where the sensor is configured to measure a force applied to the control member due to a manipulation by the user upon the control member, an actuator configured to displace a portion of the system that is engaged by the user during system operation, and a processor coupled with the sensor and the actuator. The processor is configured with control process logic to receive signals from the sensor including information relating to forces applied to the control member by the user as measured by the sensor, control movement of an object within an environment based upon the measured forces applied to the control member by the user, and control the actuator to displace the portion of the system in response to a determination by the processor of a force being applied to the object by another object within the environment.

In accordance with another example embodiment of the present invention, a method providing kinetic feedback within a system to facilitate computer-human interaction, the system including a control member configured to be manipulated by a user, a sensor coupled with the control member, an actuator configured to displace a portion of the system that is engaged by the user, and a processor coupled with the sensor and the actuator, the method comprising measuring forces applied to the control member, utilizing the sensor, due to a manipulation by the user upon the control member, providing signals from the sensor to the processor that indicate forces applied to the control member by the user as measured by the sensor, controlling movement of an object within an environment utilizing the processor, wherein the controlled movements are based upon the measured forces applied to the control member by the user, and controlling the actuator, utilizing the processor, to displace the portion of the system in response to a determination by the processor of a force being applied to the object within the environment.

The above and still further features and advantages of the present invention will become apparent upon consideration of the following detailed description of example embodiments thereof, particularly when taken in conjunction with the accompanying drawings wherein like reference numerals in the various figures are utilized to designate like components.

### BRIEF DESCRIPTION OF THE DRAWINGS

FIG. 1 is a perspective view of a kinetic feedback system in accordance with an example embodiment of the present invention.

FIG. 2 is a side view in perspective of another kinetic feedback system incorporating two kinetic feedback modules in accordance with an example embodiment of the invention.

FIG. 3 is a side view of a further kinetic feedback system incorporating a kinetic feedback module with two sensors and actuators in accordance with an example embodiment of the invention.

FIG. 4 is a schematic block diagram of an example control circuit for the system of FIG. 3.

FIGS. 5 and 6 depict an embodiment of a virtual interaction between an end effector of an object being controlled by a kinetic feedback system and a fixed object in a virtual environment according to an example embodiment of the invention.

### DETAILED DESCRIPTION

Example embodiments of the present invention facilitate physical interaction with virtual or remote (i.e. teleoperation) environments using a force input/kinetic feedback (KF) system. The KF system is configured to sense force on the part of the user to move a virtual reality object (e.g., an avatar or other virtual object) or a remote actuator or end effector of a physical object (e.g., in a telepresence environment), and provide the user with motion cues (e.g., using small actuators) to provide feedback or indicate contacts (e.g., impacts, collisions or any other applied forces to the object) in the environment in which the virtual or actual object is moved. The systems and methods described herein facilitate multi degree-of-freedom interaction between the user and the virtual and telepresence environment in which the user is effecting movement of an object. The systems and corresponding methods approach the fidelity of exoskeletal force-feedback systems, but in a much more robust and cost-effective manner. The motion cues provided to the user can be, e.g., a direct motion offset applied to a control member operable by the user that is proportional and opposite to the force encountered in the actual or virtual environment of the object being controlled, a motion pattern (e.g., a vibratory motion) applied to the control member that maps to the contact forces applied to the object being controlled (e.g., a direct motion pattern applied to the control member with frequencies and amplitudes of the motion pattern corresponding with the forces applied to the object being controlled, or a more sophisticated relationship that involves a vocabulary of motion patterns applied to the control member), and combinations of direct motion offset and motion patterns applied to the control member.

As used herein, the term “kinetic feedback” (KF) refers to the addition of force-independent motion feedback to force measuring devices (e.g., isometric, dynamic and/or other force measuring devices). In the systems incorporating kinetic feedback as described herein, when a remote or virtual object that is being controlled by an input device or control member operated by the user encounters resistance to its motion, a force is applied to the input device or control member to move it a small distance in the direction of (and, in certain scenarios, proportional to) the force produced by the collision.

For example, in a scenario in which a user is driving forward an end effector of a robot or some other device controlled by the user (in a virtual or real environment) with a force sensing controller or joystick and the end effector hits or collides with an immovable object (e.g., a wall) or a movable object, a force is applied that can move the joystick or controller in an opposing direction in relation to the forward direction in which force was applied by the user to the joystick to generate the collision, such that the joystick moves toward the user some distance. In addition, forces can be selectively applied to move the joystick in vibrations or motion patterns. Alternatively, the end effector may collide with an object without any movements of the end effector by the joystick or controller, and in such a scenario a force is still applied that can move a portion of the joystick or controller to provide a sensation or “feel” that the collision occurred to the user.

The position of the joystick or controller can be based on the force acting on sensors associated with the end effector that detect a collision such that, if the user continues to drive the end effector forward to move or go through the object, the offset of the joystick, or the amplitude of a motion pattern applied to the joystick, will remain consistent so long as the same type and degree of opposing forces are applied to the end effector. If the user controls the joystick/controller to apply less forward force to the end effector such that the end effector pushes with less force, the offset of the joystick/controller can be reduced in a complementary manner with the reduced pushing force of the end effector. If the end effector pulls away from the object in response to movement of the joystick/controller by the user, the force applied to the joystick/controller can be reduced to zero, resulting in the joystick/controller returning to its neutral position or a position that is controlled solely by the forces applied to the joystick/controller by the user.

In accordance with example embodiments of the present invention, a KF system can be configured as a peripheral device or module to facilitate user interaction with a host processor (e.g., a host computer system), where the host processor controls movements and other operations of an object in a virtual or real environment based upon manipulations by the user of a control member of the KF system. The KF system comprises at least one control member that is operable by the user and that is further coupled in some manner with at least one actuator and at least one sensor. The sensor is located at a selected location with respect to the control member and the actuator is located distally of the corresponding sensor. The KF system further comprises control circuitry and a processor or controller that controls each actuator based upon sensor measurements. Each sensor measures at least one force applied by a user to the control member, where the applied force results in a strain or deflection of the control member that is felt by the user. This measured force applied by the user translates to a corresponding degree of movement of the object being controlled by the user. The processor controls the actuator associated with the sensor to provide, when appropriate, a small motion, strain or deflection to the control member, or a vibrational pattern of motions, reflecting the force of a collision between the object being controlled and another object as relayed through the host computer from a virtual simulation or teleoperation scenario.

The control members of the KF system that are manipulated by a user to effect control of an object (real or virtual) can be of any suitable construction and design. In an example embodiment, a control member can be in the form of a rigid rod (such as a joystick as described above), where the user applies force (e.g., bending, twisting, tension, compressive forces, etc.) that slightly and measurably deforms the rod within its elastic limit. The rigid rod can be made of any suitably rigid materials, such as metal or hard plastic materials. Alternatively, the KF system can include one or more control members that are controlled by one or more digits (e.g., fingers or thumbs) of the user's hands (as shown in some of the example embodiments of the figures).

Each actuator can be any suitable one or more types of linear or rotary actuators such as a servo or stepper motor, solenoid, or voice coil. The KF system includes a processor to receive and process data corresponding to applied force information input by the joystick or control member manipulated by a user of the system, as measured by one or more sensors associated with the joystick/control member, and also to determine forces applied to the object being controlled by the system (e.g., based upon output from remote sensors associated with a physical object being controlled by the system or spatial information associated with a virtual object that is provided by software that generates the object and a virtual environment for the object).

The processor can be implemented in a host computer system, where processed data from sensors is transferred in a format compatible with the host computer system and facilitates user interaction with the host computer system via control member manipulation by the user. The processor then takes output information from the host computer and converts that into positional information that can be used by the actuator. The host computer system processes the information to update or respond to events within an executing software application (e.g., a virtual environment or remote, telepresence environment). A plurality of control members can be connected in any suitable manner to each other via one or more suitable connectors to form a frame that can be customized based upon user preference and/or a particular application.

The example embodiments of KF systems described in accordance with the present invention include a number of benefits that include, without limitation:

1. A reduction in cost of the system in relation to other force measurement systems. This is because motion is used as a user cue rather than the basis of the interaction, and the primary structure of the interface is rigid. Force measurement, through the use of sensors such as strain gauge sensors or other sensors such as pressure sensing variable resistors, is inexpensive (e.g., only a few dollars for each strain gauge sensor per degree-of-freedom (DOF) measurement). In addition, simple mechanical actuators (e.g., open loop actuators such as linear voice coil motors that cost a few dollars each) can be utilized to provide a motion feedback component of the system. In addition, the manufacturing costs are reduced due to the system design, in which there are very few moving components.

2. The feedback components of the systems are safe. The mechanical actuators that provide a KF force in response to encountering an immovable object or a resisting object by the object (or an end effector of the object) being controlled by the user are designed to be mechanically safe in that they effect movement of a portion of the control member (e.g., a joystick) only small distances that cannot cause injury to the user.

3. The frames of the systems can be designed with simple, rugged mechanisms that result in inherently tough systems resistant to damage during use. In addition, the systems can be designed without any tight tolerances that would otherwise be required for an interface with many moving parts, so that the systems can be easily disassembled and reassembled for transport.

4. The KF systems of the present invention allow for measurement of forces applied by the user to a control member in many degrees of freedom, such that literally any level or type of control member interface (e.g., from a single joystick to a full exoskeleton including a plurality of control members) can be achieved with only minor increases in complexity. This facilitates the possibility of many different levels of interaction between a user of a KF system and an object or an end effector of an object to be controlled in a real, physical or virtual/computer simulated environment.

As noted above, the KF systems of the present invention embodiments are interactive as a peripheral device for a host processor, such as a host computer system, so as to enhance the level of interaction with virtual or physical (e.g., remote or telepresence) environments. In particular, the KF systems can be configured to communicate with a host computer system to facilitate user haptic interaction with virtual reality simulation scenarios generated by the host computer system based on force inputs by the user manipulating one or more control members of the KF system. Alternatively, the KF systems of the present invention can be configured to communicate with a host telepresence system to facilitate user tactile interaction with remote environments directed by force inputs by the user manipulating the control member(s).

The KF systems can be designed to be modular, for example, by increasing or decreasing the number of control member components and corresponding sensors and force actuators from a system configuration based upon a particular scenario so as to customize or optimize the types of user actions in controlling an object (or an end effector of an object) for the scenario.

Specific example embodiments are now described with references to the figures.

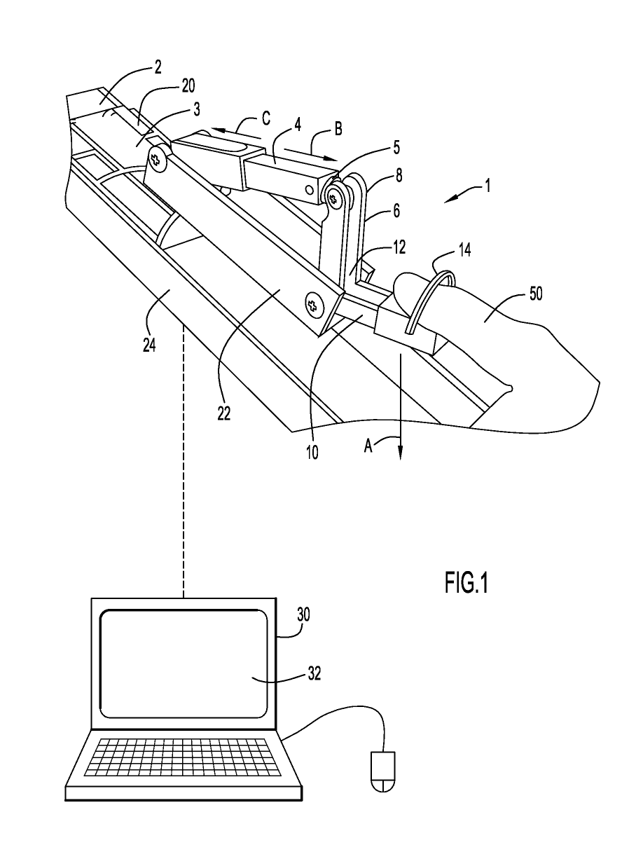

Referring to FIG. 1, a force-input, KF system that is operable by a digit of a user's hand (e.g., the forefinger) is shown. In particular, system 1 includes a generally rectangular base 2 to which one or more sensors and one or more actuators are connected. The base 2 has a generally U-shaped configuration with a lower wall 20 and two opposing side walls 22 extending from the lower wall 20. The base 2 is secured to a reference frame 24. The reference frame 24 provides a physical framework for the system and also serves as a reference or aid to the user in accurately determining the amount of motion of a control member (e.g., as moved by the user or by the actuator acting on the control member).

As shown in FIG. 1, a sensor 3 is mounted to the lower wall 20 of the base 2 between the base 2 and an actuator 4. The actuator 4 comprises a generally rectangular housing with an actuating member disposed therein. The actuating member can comprise any suitable structure that effects movement of an end of the actuating member in a particular direction. Examples of types of actuating members include, without limitation, a linear or rotary actuator, such as a servo or stepper motor, solenoid, or voice coil. The actuating member includes a first end that secures to the sensor 3 and a second end 5 that secures to an end of a control 6 that a user moves to effect control of an object in a physical (i.e., real world) or virtual (i.e., computer simulated) environment. The control member 6 comprises an L-shaped member including a first end 8 that pivotally connects to an end 5 of the actuator 4 and a second, free end 10 that is configured to be engaged by the user (e.g., by a digit of a user's hand, such as the user's forefinger 50 as shown in FIG. 1). A central portion 12 of the control member 6 (the portion at which the two legs of the L-shaped member join) is disposed between and is pivotally connected to the side walls 22 of the base 2. The control member 6 can also include any suitable type of clip structure 14 located at its free end 10 to provide a securing engagement between the user's digit (e.g., the forefinger 50 as shown in FIG. 1) and the control free end 10 during use of the system 1.

In the embodiment of FIG. 1, the sensor 3 comprises a strain gauge sensor having an elongated axis that is generally aligned with the elongated axis of the base 2 and the actuator 4 such that a pulling force applied to the sensor 3 by the actuator member as a result of a downward force applied to the free end 10 of the control member 6 results in some degree of stretching or elongation of the sensor 3 that is measurable. However, it is noted that any other suitable sensor can also be utilized that measures the degree of force applied by the user to the control free end 10.

Any suitable type of force sensing sensor can be utilized, such as a strain gauge sensor comprising a metallic wire or foil device. When a strain gauge is applied in a suitable orientation to an object (e.g., the lower wall 20 of the base 2 for the system 1), the strain gauge electrical resistance varies in proportion to the amount of a particular strain applied to the object. The change in resistance of the strain gauge is measurable, e.g., utilizing a conventional Wheatstone bridge configuration, where the strain gauge forms one of the resistors in the bridge. The Wheatstone bridge can be configured in any suitable manner to determine the change in resistance of the strain gauge. For example, when the strain gauge and the object to which the strain gauge is applied undergo a strain deformation, the change in resistance of the strain gauge can be easily determined by comparing a measured voltage across the bridge with a reference voltage and processing the voltage difference.

Movement of the free end 10 of the control member 6 in a downward direction toward the reference frame 24 (e.g.., by the user's forefinger 50 pressing downward on the free end 10 as shown by arrow A in FIG. 1) results in a pulling force at the end 5 of the actuator member and a pulling force to the end of the actuator connected to the sensor 3 toward the user (as shown by arrow B in FIG. 1). This in turn applies a strain to the sensor 3 and the lower wall 20 of the base 2 to which it is attached. The strain deformation is measurable to provide a degree or amount of force applied by the user, which can be translated to a degree of movement of the object to be controlled by the user.

The actuator 4 can comprise any structural configuration that effects a movement of the actuating member end 5 in a particular direction or movement through a particular pattern of motion (e.g., a series of vibrations). In particular, the actuator 4 is operable, under certain system conditions, such that movement of the actuating member end 5 also moves the control member 6 to provide a sensation or “feel” for the user when an impact or collision occurs between the object being controlled by the system 1 and another object. For example, the actuator 4 can move in a direction opposite of the movement of the control member end 8 (e.g., in a direction indicated by arrow C in FIG. 1). Such movement of the actuator 4 can provide resistance to the downward force applied by the user to the free end 10 of the control member 6 (e.g., in a scenario in which the user continues to press on the control member 6 in an attempt to move the object in a forward direction within the object's environment, where the object has contacted another object, such as an immovable wall). The actuator 4 can also move in a back-and-forth vibrating motion, with a selected frequency and amplitude of the force applied by the actuator 4, to also provide the sensation to the user that an impact or collision has occurred.

The actuating member of the actuator 4 can comprise, e.g., a linear or rotary actuator, such as a servo or stepper motor, solenoid, or voice coil. In the embodiment described in FIG. 1, the actuating member comprises a linear actuator including a stepper motor that is controlled by an actuator or motor controller so as to selectively effect movement in small incremental distances of the actuating member end 5 (e.g., in the direction indicated by arrow C in FIG. 1). For example, the stepper motor can be configured as a brushless, synchronous electric motor that is capable of dividing a full rotation of the motor into a suitably great number of steps, which results in correspondingly small incremental movements of the actuating member. The motor's position can be controlled precisely without any feedback mechanism. Since the displacement of the actuator is quite small, the motor can be strong enough to overcome any reasonable resistance offered by the user on the control member 6 without risk of injury to the user.

The actuator controller and sensor 3 of the system 1 are coupled in any suitable manner (e.g., via a hardwire or wireless connection) with a processor 30. The processor 30 can be incorporated within the system 1 (e.g., within the frame 24) or, alternatively, the processor 30 can be incorporated in a separate computer system (shown as the computer system 30 in FIG. 1) that is in communication with the system 1. When the processor 30 is incorporated into a separate computer system, the system 1 can connect with the computer system in any suitable manner as a peripheral component of the computer system.

The processor 30 receives signals from the sensor 3 to provide an indication of an amount or a degree of strain applied to the sensor 3 and also controls the motor controller of the actuator 4 to control the stepper motor based upon environmental conditions of the object being controlled by the system 1. The processor 30 is further coupled to communicate with object being controlled by the system 1 (e.g., to receive information from a local controller for the object and provide control signals to the local controller). The object being controlled by the user can either be a remotely controlled object (e.g., a robotic device with a robotic arm or end effector) or a virtual or computer simulated object (e.g., a computer simulated object). In either scenario, the processor 30 controls movements of the object (e.g., controlling movements of an end effector of the object) based at least in part upon manipulations of the control member 6 by the user.

In a scenario in which the object is a physical object being remotely controlled by teleoperation utilizing the system 1, the processor 30 communicates (e.g., via a hardwired or wireless communication link) with a local controller of the object to effect control of the remote object based upon user manipulations of the control member 6. The local controller of the object can include any suitable number and types of sensors that detect motions of the object and forces applied to the object, e.g., due to the object colliding with or contacting another object. In a virtual or computer simulated environment, the object is a virtual object that is controlled by software in a computer system that includes the processor 30, where the processor 30 controls operation of the software to control virtual movements of the object. In the computer simulated environment, the software controlled by the processor 30 provides information about the simulated environment in which the object moves, including information regarding collisions or contact with other objects. The virtual object can be displayed (e.g., utilizing computer gaming and/or other virtual reality software), by an electronic visual display 32 of the computer system (e.g., an LCD display). In addition, depending upon the location of the remote physical object (e.g., the remote physical object may be some distance and thus out of visual range from the user), the display 32 of the computer system 30 can also provide a video image of the remote physical object (utilizing information received from local cameras or other video monitoring devices that record movements of the object) to allow the user to view operations of the remote physical object (including movements that are controlled by the user via operation of the control member 6).

The system 1 of FIG. 1 includes a single sensor 3 to detect a single degree of freedom of movement by the user manipulating a control member to effect control on another physical or virtual object. However, as previously noted, KF systems can be configured in accordance with the present invention to detect multiple degrees of movement by the user to effect object control. For example, systems can be easily configured in accordance with present invention embodiments to include a plurality of sensors that detect spatial movements by the user manipulating one or more control members in a variety of different directions.

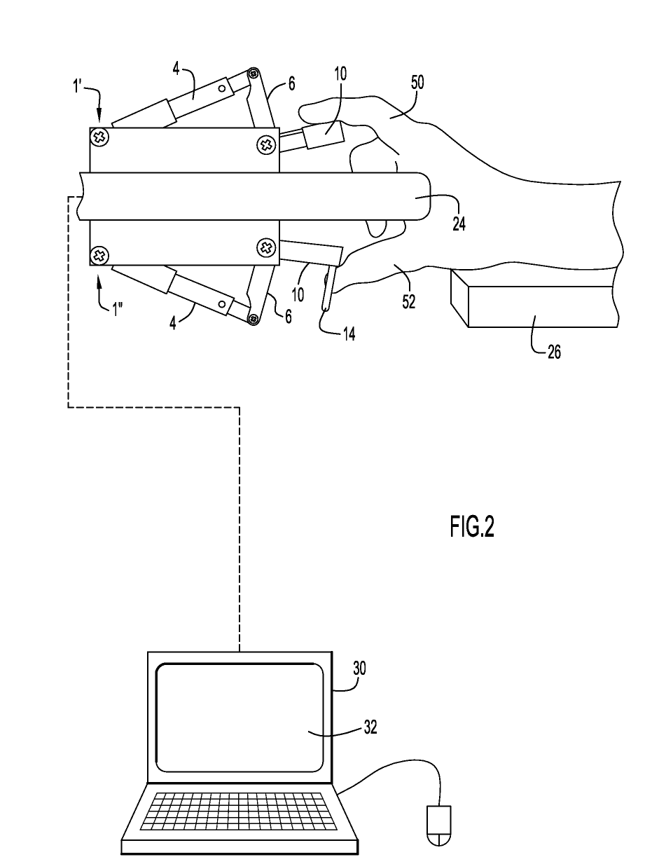

Referring to the example depicted in FIG. 2, two modules 1′, 1″ are connected on opposing surfaces of a reference frame 24 to form a single system, where each module 1′, 1″ is the same or substantially similar to the system embodiment depicted in FIG. 1. In particular, each module 1′, 1″ includes a sensor 3, an actuator 4 and a control member 6 that operate in the same or substantially similar manner as previously described for the system 1 of FIG. 1 (i.e., each control member 6 is pressed toward the reference frame 24 to achieve a measured movement by the user's digits due to the strain of the corresponding strain gauge sensor 30.

As shown in FIG. 2, the user engages a forefinger 50 to the control member 6 of module 1′ and a thumb 52 to the control 6 of module 1″ in order to facilitate a detection of two degrees of freedom of movement by the user via the two sensors 3 associated with the modules 1′, 1″. The system can be further modified to include any selected number of the same or substantially similar types of modules that are capable of detecting spatial movement for some or all of the user's fingers in order to control various degrees of freedom of movement of an object associated with the system. In addition, the modules can be designed to detect any one or more types of spatial movements (e.g., linear and/or rotary movements in one or more dimensions) for one or more body portions of the user. Each module (e.g., each of modules 1′ and 1″) can include a single sensor or a plurality of sensors that are aligned in different directions (e.g., parallel or transverse to each other) to measure elongation or stretch of a sensor, compression of a sensor, twisting of a sensor and/or any other types of deformations to a sensor which correspond with particular spatial movements by the user (e.g., movements by one or more of the user's hand or individual fingers in different spatial directions).

In the system of FIG. 2, the module 1″ includes a clip structure 14 to secure engagement of the user's thumb 52 to the free end 10 of the control member 6. It is noted that such a clip structure can be provided for each module or for only selected modules. In addition, a further reference frame 26 is provided that is separate from reference frame 24. The reference frame 26 is positioned to allow the user to place his or her wrist and forearm on or near the reference frame 26 while engaging one or more control members 6 with the user's digits (finger(s) and/or thumb), and the reference frame 26 provides the user with a reference aid to determine the amount of movement of the control member 6 or the actuator 4 during system operation.

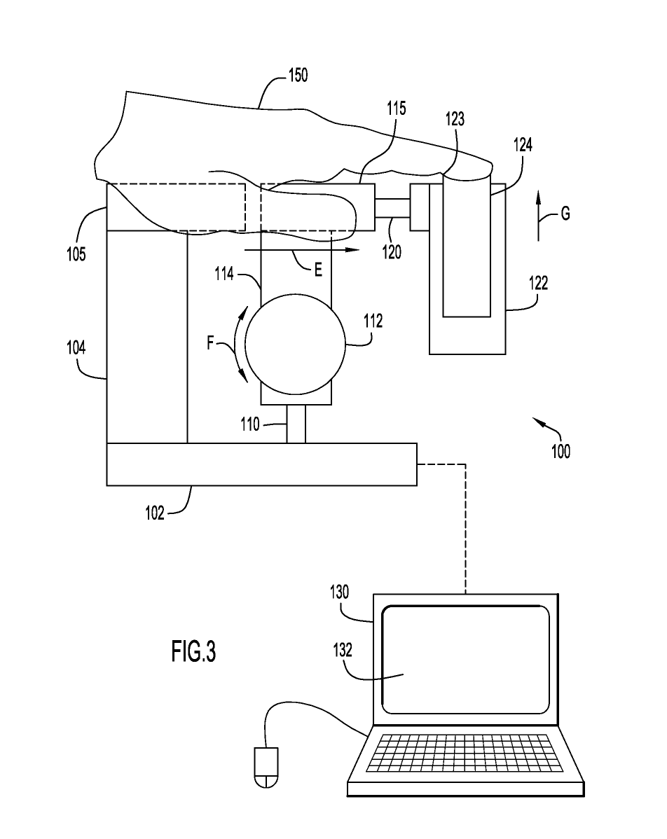

A further example embodiment of a KF system in accordance with the present invention is depicted in FIG. 3. The KF system 100 includes a reference frame including a generally rectangular base member 102 that is supported on a supporting surface (e.g., a desk or a table), a generally rectangular column 104 that extends vertically in a generally perpendicular orientation from the base member 102, and a generally rectangular upper member 105 that rests on the upper end of and extends transversely from the column 104, where the upper member 105 has a lengthwise dimension that is less than the lengthwise dimension of the base member 102. The upper member 105 provides a support surface for a user's hand 150 (e.g., the palm of the user's hand) when the user engages and manipulates the control members of the system 100.

The KF system 100 includes two control members with associated sensors and actuators that measure two degrees of freedom of movement by the user during operational control of a virtual or remote physical object. In particular, a first portion of the system 100 includes a sensor bar 110 that extends in a generally perpendicular orientation from the base member 102 and connects with a rotary actuator 112. The rotary actuator 112 also connects with a control member 114. The control member 114 has an inverted L-shaped configuration in relation to the sensor bar 110 and rotary actuator 112, and an upper end of the control member 114 includes an upper contact surface 115 that is generally planar with an upper contact surface of the upper member 105 of the reference frame. This allows a portion of the palm of the user's hand 150 to engage with the upper contact surface 115. The first portion, including the sensor bar 110, rotary actuator 112, and control member 114, are separated from the column 104 and upper member 105 of the reference frame such that there is a slight gap between the control member 114 and the upper member 105.

Thus, the first portion is cantilevered with the base member 102 of the reference frame. The sensor bar 110 includes a strain gauge sensor that is generally aligned along the longitudinal or lengthwise dimension of the sensor bar 110 so as to measure any strains or slight deflections or deformations to the sensor bar 110 caused by any shear force applied by the palm of the user's hand 150 to the upper contact surface 115 of the control member 114 (e.g., when the palm of the user's hand 150 moves in a direction shown by arrow E shown in FIG. 3). The rotary actuator 112 is operable to slightly rotate in clockwise and counterclockwise directions as shown in FIG. 3 (e.g., in the directions indicated by the arrows designated by F), which causes corresponding movement of the L-shaped control member 114, based upon sensor measurements associated with the sensor bar 110.

The second portion of the system 100 includes a sensor bar 120 that is secured at one end and extends transversely from a free end of the upper portion of the inverted L-shaped control member 114. The sensor bar 120 includes a strain gauge sensor that is generally aligned along the longitudinal or lengthwise dimension of the sensor bar 120 so as to measure any strains or slight deflections or deformations applied to the sensor bar 120 by the user's finger. Attached to the other end of the sensor bar 120 is another control member 122. The control member 122 is generally rectangular and extends along its lengthwise dimension and in a cantilevered manner from the sensor bar 120 downward a selected distance toward the base member 102 of the reference frame. The dimensions of components of the first and second portions of the system 100 are configured such that an upper contact surface 123 of the control member 122 is generally planar with the upper contact surface 115 of the control member 114 and one or more fingers of the user's hand 150 are positioned directly over this upper surface 123 when a portion of the user's palm is disposed over the upper contact surface 115.

Disposed within a portion of the control member 122 is a linear actuator member 124 that extends to and defines a portion of the upper surface 123 of the control member 124 which is engaged by one or more fingers of the user's hand 150. The linear actuator member 124 is actuated (e.g., in a similar manner as linear actuators described in previous embodiments, such as with a servo or stepper motor) so as to provide small, incremental movements of the actuator member 124 in a direction away from the base member 102 and toward the user's finger(s) (e.g., in a direction as indicated by arrow G in FIG. 3) in response to measurements of the strain gauge sensor associated with sensor bar 120.

The actuators 112, 124 and the sensors of the sensor bars 110, 120 of the system 100 are coupled in any suitable manner (e.g., via a hardwire or wireless connection) with a processor 130. As noted with the previous embodiments, the processor 130 can be incorporated within the system 100 or within a computer system that communicates with the system (as shown in FIG. 3), where the system 100 is configured to connect with the computer system as a peripheral device. The processor 130 receives signals from the sensors to provide an indication of an amount or a degree of strain applied to each sensor and also controls the actuators 112, 124 based upon system conditions. The processor 130 is further coupled with an object being controlled by the user via user manipulation of the control members 114, 122, where the object being controlled by the user can either be a remote controlled object (e.g., a robotic device with a robotic arm or end effector) or a virtual or computer simulated object (e.g., a computer simulated object). In either scenario, the processor 130 controls movements of the object (e.g., controlling movements of an end effector of the object) based at least in part upon manipulations of the control members 112, 124 by the user.

As previously noted, the system of FIG. 3 provides two DOFs (degrees of freedom) for detecting movements by the user's hand 150, where movements are detected by the user manipulating control members 114, 122 to control movements of the remote physical or virtual (i.e., computer simulated) object. The strain gauge sensors of the sensor bars 110, 120 measure two forces applied by the user's hand 150 to the system 100. The sensor associated with sensor bar 120 measures forces applied by one or more fingers of the user to the control member 122, while the sensor associated with the sensor bar 110 measures shear forces applied by the user's palm to the upper contact surface 115 of the control member 114. The system 100 could further be configured to include additional control members, additional sensors and/or additional actuators as desired to provide additional DOF for the system 100.

The reference frame comprising members 102, 104 and 105 remain in a fixed position during movement of the user's hand 150 in relation to the control members 114, 122, and this allows the user to have a strong and precise sensation of movement, where the user can sense motion between the tip and base of the user's one or more fingers that apply pressure to the surface 123 of the control member 122.

The actuators 112, 124 are controlled by the processor 130 to move in the directions described above (as shown by arrows F and G in FIG. 3) based upon a determination that the remote physical or virtual object being controlled by the user contacts or collides with another object. The degree of movement of the actuators 112, 124 is based upon the amount of force applied to the remote physical or virtual object by the other object with which it collides. While this force can be a result of the controlling movement of the remote object by the user, it is important to note that there is no direct coupling of the forces applied by the user to the control members 114, 122 to the motion of the actuators 112, 124. For example, the user could be exerting no force whatsoever upon either control member 114, 122, while in a simulated or telepresence environment the remote controlled physical or virtual object hits or collides with another object (and the collision and corresponding forces associated with the collision are detected by the processor 130). The collision force and the degree of such collision force results in activation of one or both actuators 112, 124 to provide an indication, sense or “feeling” to the user that a collision occurred (as well as a degree of such collision).

The movements of the actuators 112, 124 when a collision occurs are slight or small. The movements can be constant (e.g. the linear actuator 124 moves 2 mm based upon a constant force of 0.25 Newtons being applied to the remote object) or it may move through a pattern (e.g., the linear actuator 124 oscillating up and down through a 1 mm range at a frequency of 60 Hz based upon a constant force of 0.25 Newtons being applied to the remote object). The motion by each actuator 112, 124 is felt by the user, since the user's hand 150 moves with respect to the reference frame as a result of movement of the actuators.

As with the previous embodiments, the processor 130 includes suitable information about the object being controlled by the system 100 in order to assess when and to what degree the object has been subjected to some force (e.g., due to a collision or contact with another object). For a physical object being controlled by the system 100 (e.g., in a telepresence environment), the processor 130 communicates (e.g., via a hardwire or wireless link) with a local controller associated with the object, where the local controller is further in communication with any suitable number and types of sensors that provide information about forces applied to the object. The processor 130 obtains such information from the local controller in order to assess whether and to what degree one or both actuators 112, 124 are to be moved within the system 100. In a virtual or computer simulated environment, software is run on the computer system including the processor 130, and the software provides all necessary information regarding the simulated environment in which the object moves and experiences forces applied to it. The computer system further includes a display 132 (e.g., an LCD display) to provide a visual indication showing movements of the object to the user.

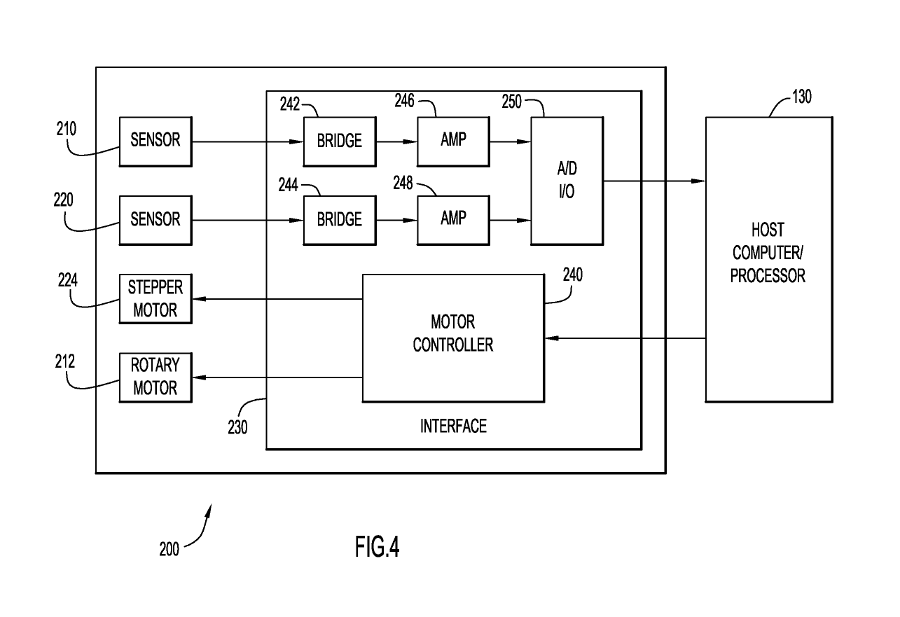

A schematic block diagram of an example control circuit for the system 100 of FIG. 3 a system utilizing one or more sensors (such as the systems depicted in FIGS. 1 and 2) is now described with reference to FIG. 4. In particular, the control circuit 200 includes an interface 230 that connects via any suitable standard peripheral connection port (e.g., serial, parallel, USB, etc.) with the processor/host computer system 130. Two strain gauge sensors 210, 200 (which correspond with the sensor bars 110, 120 of the system of FIG. 3) connect, e.g., via individual wires, to the interface 230. The interface 230 includes a Wheatstone bridge 242 and 244 for each strain gauge sensor 210, 220. The resistance output of each bridge 242, 244 is converted into voltage by a corresponding amplifier 246, 248, which is in turn digitized by an analog to digital Input/Output (I/O) device 250. The I/O device 250 converts such measured information into readable data packets for processing by the processor/host computer system 130.

The control circuit further includes a stepper motor 224 that corresponds with the linear actuator 124 and a rotary motor 212 that corresponds with the rotary actuator 112. Each motor 212, 224 connects (e.g., via a hardwire connection) with a motor controller unit 240 of the interface 230. The motor controller unit 240 is configured to independently and separately control the operation of each motor 212, 224. The motor controller 240 is also coupled via the interface 230 with the host computer system 130 to facilitate control of each motor 212, 224 by the processor/host computer system 130 during system operation.

As previously noted, the embodiments of the present invention provide kinetic feedback information to the user during system operation when a first object (a virtual object or physically remote object) being controlled by the user is moved into an impact or collision with another or second object within the first object's environment. The systems are designed such that, upon and during the time period in which the first object impacts or remains in contact (after impact) with the second object, the processor controls one or more actuators to apply a force and resultant movement (e.g., in slight or small increments) to one or more control members that are manipulated by the user to effect movement of an object (e.g., an object within a computer simulated or telepresence environment). The degree or amount of force applied by the actuator(s) can be selectively adjusted by the processor to correspond with the degree of impact between the object and another object within the object's environment, and the degree of impact may or may not be the result of the amount of force applied by the user to the control member(s). In addition, the actuators can be controlled to provide a direct and constant offset motion to one or more control members or a pattern of offset motions (e.g., vibratory motions having a selected offset amplitude and frequency) that provide kinetic feedback to the user.

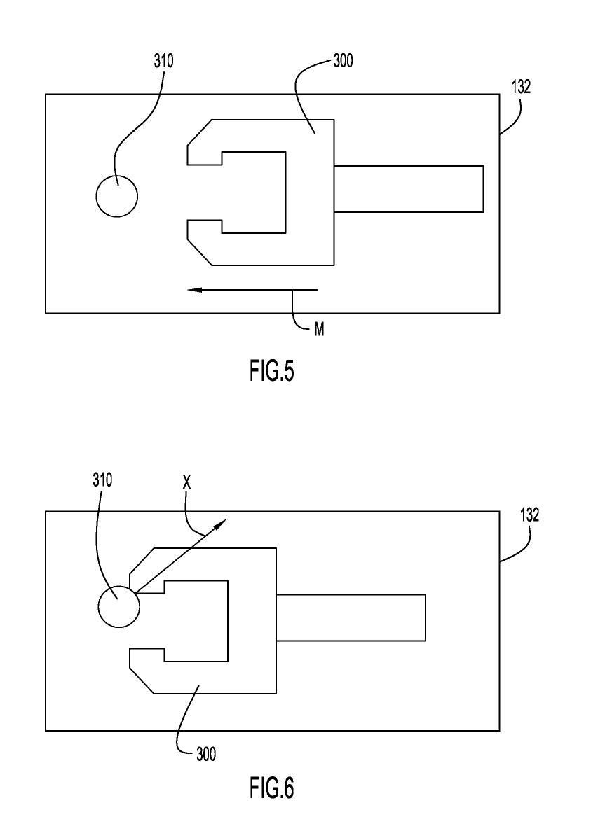

Operation of a KF system in accordance with the present invention embodiments is now described with reference to the system of FIG. 3, the circuit diagram of FIG. 4 and the display images depicted in FIGS. 5 and 6. It is noted that, despite the structural differences in the control members and how they may be manipulated by a user, the other embodiments are operable in a similar manner in that the KF system facilitates control of movements of an object based upon manipulations of the control member(s) by the user and further activates one or more actuators that provide feedback to the user based upon forces that are applied to the object being controlled by the KF system.

In addition, system operation involves the use of a host computer system 130 including a processor that utilizes software stored within a storage module of the computer system 130, where the software provides a computer simulated environment in which a virtual object is manipulated utilizing the system 100. FIGS. 5 and 6 depict the virtual object, in the form of an end effector 300, that is displayed on the display 132 of the computer system 130.

The user places his or her hand 150 upon the upper member 105 of the reference frame such that a portion of the user's palm is disposed over the contact surface 115 of the control member 114 and one or more fingers are disposed over the contact surface 123 of the control member 122. Movements of the user's hand and/or fingers which exert a force upon control member 114 or control member 122 result in strain measurements by the sensors 210, 220 associated with strain bars 110, 120, and these sensor measurements, in the form of resistance values, are provided to the Wheatstone bridges 242, 244 of the interface 230 of the control circuit 200. The bridges 242, 244 output signals which are amplified by amplifiers 246, 248 and converted to digital signals output for use by the host computer processor 130. The host computer processor 130 utilizes such digital signals to control operation of the end effector 300 in its virtual environment, such as a movement of the end effector 300 in a direction as shown by the arrow M in FIG. 5. The controlled operation of the end effector 300, including its controlled movements within its virtual environment, are visually depicted by the display 132.

When the end effector 300 collides or makes contact with another object 310 within its virtual environment as shown by the display 132 in FIG. 6, the host computer processor 130 identifies (utilizing the software that is running the virtual environment scenario) this collision as well as the types and magnitudes of one or more forces acting on the end effector 300 by the object 310. Such contact between the end effector 300 and the object 310 in the virtual environment can be the result of the end effector 300 being moved (e.g., in the direction indicated by arrow M in FIG. 5) as a result of the manipulations by the user of the control members 114, 122, where the degree of force exerted upon the control members 114, 122 by the user's hand 150 is determined by sensors 210, 220 and the host computer processor 130 translates such manipulations into corresponding movements of the end effector 300. Alternatively, the contact between the end effector 300 and the object 310 can be independent of any controlled movements of the end effector 300 by the user manipulating the control members 114, 122 (e.g., the object 310 may move into a collision with the end effector 300 while the end effector 300 is stationary within the virtual environment).

In the scenario depicted by the display 132 in FIG. 6, the contact between the object 310 and the end effector 300 results in the object 310 exerting a force upon the end effector 300 shown by the force vector arrow X. The host computer processor 130 determines the force components into three dimensional coordinates that correspond with the KF system 100, and then the host computer processor 130 provides control signals to the motor controller 240 to engage one or both of the stepper motor 224 and the rotary motor 212 to correspond with the forces applied to the end effector 300 by the object 301. This results in one or both of a linear movement of the linear actuator 124 in the direction indicated by arrow G in FIG. 3 and a rotational movement of the rotary actuator 112 in a counter clockwise direction indicated generally by arrow F in FIG. 3. Such movements by either or both actuators 112, 124 provide a slight displacement of a portion of the palm and/or finger(s) of the user's hand 150 with respect to the control members 114, 122 and/or portions of the reference frame, which in turn provides kinetic feedback in the form of a sensation or feeling to the user of the collision or contact between the end effector 300 and the object 310 has occurred. In addition, the actuation of different actuators and a degree of displacement of the actuators as controlled by the host computer processor 130 provides the user with kinetic feedback regarding the direction of such forces as well as the magnitude of such forces that are applied to the end effector 300 due to the contact with the object 310.

Thus, the example embodiments of the present invention provide an effective system and corresponding methods for providing kinetic feedback to a user controlling an object in a virtual environment or a physical environment (e.g., via teleoperation of the object).

As previously noted, the kinetic feedback motion cues provided by the system can be in the form of a direct motion offset applied to a control member operable by the user that is proportional and opposite to the force encountered in the actual or virtual environment of the object being controlled, a motion pattern (e.g., a vibratory motion) applied to the control member that maps to the contact forces applied to the object being controlled (e.g., a direct motion pattern applied to the control member with frequencies and amplitudes of the motion pattern corresponding with the forces applied to the object being controlled, or a more sophisticated relationship that involves a vocabulary of motion patterns applied to the control member), and combinations of direct motion offset and motion patterns applied to the control member. In particular, the use of an opposing motion in conjunction with motion patterns applied by the system in response to the object being controlled encountering a force within its environment allows for a haptic interaction that contains more information to the user and is as such capable of richer levels of interaction. For example, a sawtooth motion pattern can be applied by the system to impart harder vibrations to one or more control members operated by the user when a hard surface (or contact with another object that applies a greater force to the object) is encountered by the object being controlled within the environment of the object, while a sinusoidal motion pattern can be applied by the system to impart softer vibrations to one or more control members operated by the user when the object being controlled encounters a soft surface (or a contact with another object that applies a smaller force to the object). The difference in vibrational patterns are noticed by the user, and the user can correlate these patterns with the object's environment and the types of forces or surfaces the object being controlled is encountering at any given time during system operation.

It will be appreciated that the example embodiments described above and illustrated in the drawings represent only a few of the many ways of implementing a kinetic feedback system and corresponding method in accordance with the present invention.

For example, any number of KF system modules may be combined in selected arrangements and orientations utilizing any suitable connectors (e.g., lug nuts, couplings, tee or wye fittings, cross fittings, etc.) to provide a system structure for interfacing with a user, where each module includes at least one control member that is manipulated by a user, at least one sensor that senses manipulations of the at least one control member, and at least one actuator that is configured to be displaced and/or displace portions of the at least one control member for providing kinetic feedback to the user during system operation. For example, two modules may be connected so that an actuator of one module becomes the mounting base for the next module, which is rotated 90 degrees with respect to the first module such that a user may have two DOF in their interaction. In another example, a collection of five modules could be arranged in a ‘glove-like’ arrangement such that the user may have interaction for a hand. In yet another example, a user may step into a full exoskeleton that contains many modules that provide interaction for hands, feet, legs and head.

The kinetic feedback system and corresponding components (e.g., control members, actuators, sensors, etc.) may be of any size or shape and may be constructed of any suitable materials.

The sensors may be constructed of any suitable materials that preferably are subject to measurable deflection within an elastic limit of the control members when subjected to one or more straining or other manipulations/forces by the user. The actuators may be any electronically controllable device that is capable of converting electrical impulses, current or voltage into positional displacements of some portion of the system that provides kinetic feedback to the user. The complete system may have any selected number of modules and/or any suitable geometric configurations, and two or more modules may be combined in any suitable manner to yield a system frame that conforms to a desired design for a user for a particular application. Any suitable number of modules may be applied to a framework to facilitate interaction with the user (e.g., bending, twisting, compression and/or tension).

Any suitable connector may be utilized to connect any two or more control members together, including, without limitation, lug nuts, couplings, tee fittings, wye fittings and cross fittings. Any number of connectors may be utilized to form a system frame of control members. The connectors may be constructed of any suitable materials. The frame may include any quantity of any type of seat or other user support structure disposed at any locations to support a user or user body portions.

Any suitable number of sensors may be utilized to measure any type of strain or other force applied to any suitable number of control members. The sensors may be constructed of any suitable materials, may be disposed at any locations in relation to the control members and may be of any suitable type (e.g., strain gauge, etc.). Further, the sensors may include any electrical, mechanical or chemical properties that vary in a measurable manner in response to applied force to measure force applied to an object.

Any suitable number of actuators may be utilized to provide any type of positional change applied to any suitable number of control members and/or any other portions of the systems. The actuators may be disposed at any suitable locations in relation to the control members and may further be of any suitable one or more types (e.g., stepper motor, servo motor, voice coil, bladder and pump, muscle, etc.). Further, the actuators may include any electrical, mechanical or chemical properties that provide motion or force in a predictable manner in response to signals.

The interface of the control circuit be implemented by any quantity of any type of microprocessor or other circuitry, while the interface may be disposed at any suitable locations on the system frame or, alternatively, remote from the system frame. The control circuitry and/or processor may communicate with the sensors and actuators via any suitable wiring or wireless connections. The interface may be connected to one or more host computer systems via any suitable peripheral or other port of the computer systems. The processor may further arrange digital data representing force measurements by sensors into any suitable data packet format that is recognizable by the host computer systems receiving data packets from the processor. The data packets may be of any desired length, include any desired information and be arranged in any desired format.

The interface may sample the measurements or provide actuator control at any desired rate (e.g., seconds, milliseconds, microseconds, etc.), or receive measurement values and provide actuator signals in response to interrupts. The analog values may be converted to a digital value having any desired quantity of bits or resolution. The processor may process the raw digital measurements in any desired fashion to produce information for transference to the host computer system.

Any suitable number of any types of conventional or other circuitry may be utilized to implement the interface amplifiers, sensors, A/D converters, D/A converters and processor. The amplifiers may produce an amplified value in any desired voltage range, the A/D converters may produce a digitized value having any desired resolution or quantity of bits (e.g., signed or unsigned), and the D/A converters may take a digitized value having any desired resolution or quantity of bits (e.g., signed or unsigned) to produce an analog signal of any desired voltage range or current. The interface may include any quantity of the above or other components arranged in any fashion. The resistance change of the sensors may be determined in any manner via any suitable conventional (e.g., Wheatstone bridge, etc.) or other circuitry. The motor control may be provided via any suitable conventional (e.g. Pulse-width modulation) or other circuitry. The amplifiers and processors may be separate within a circuit or integrated as a single unit.

Any suitable number of any type of conventional or other displays may be connected to the processor to provide any type of information relating to a particular computer kinetic feedback session. A display may be located at any suitable location on or remote from the kinetic feedback system.

Any suitable number of additional input devices may be provided for the system to enhance operation. The input devices may be provided on any suitable number of control panels that are accessible by the user during system operation and have any suitable configuration (e.g., buttons, switches, keypads, etc.). Optionally, input devices may be provided (e.g., foot pedals, stairs, ski type exercisers, treadmills, etc.) that provide features in addition to the kinetic feedback features provided by modules. The additional input devices may further be controlled by the interface.

The host computer system may be implemented by any quantity of any personal or other type of computer or processing system (e.g., IBM-compatible, Apple, Macintosh, laptop, palm pilot, microprocessor, smart phone, tablet, etc.). The host computer system may include any commercially available operating system (e.g., Windows, OS/2, Unix, Linux, etc.), any commercially available and/or custom software (e.g., communications software, application software, etc.) and any types of input devices (e.g., keyboard, mouse, microphone, voice recognition, etc.). It is to be understood that the software of the host system and/or processor may be implemented in any desired computer language, and could be developed by one of ordinary skill in the computer and/or programming arts based on the functional description contained herein. Further, any references herein of software performing various functions generally refer to computer systems or processors performing those functions under software control. The processor may alternatively be implemented by hardware or other processing circuitry, or may be implemented on the host computer system as software and/or hardware modules receiving the sensor measurements. The various functions of the processor may be distributed in any manner among any quantity (e.g., one or more) of hardware and/or software modules or units, computer or processing systems or circuitry, where the computer or processing systems or circuitry may be disposed locally or remotely of each other and communicate via any suitable communications medium (e.g., LAN, WAN, Intranet, Internet, hardwire, modem connection, wireless, etc.). The software and/or algorithms described above may be modified in any manner that accomplishes the functions described herein.

From the foregoing description, it will be appreciated that the invention makes available a novel kinetic feedback system and method for computer-human interaction to facilitate user interaction with a host computer system.

It is to be understood that the terms “top”, “bottom”, “front”, “rear”, “side”, “height”, “length”, “width”, “upper”, “lower”, “vertical” and the like are used herein merely to describe points of reference and do not limit the present invention to any particular orientation or configuration.

Having described embodiments of providing kinetic feedback for computer-human interaction in virtual or remote operation environments, variations and changes will be suggested to those skilled in the art in view of the teachings set forth herein. It is therefore to be understood that all such variations, modifications and changes are believed to fall within the scope of the present invention as defined by the appended claims.

What is claimed is:

1. A kinetic feedback system for facilitating computer-human interaction, the system comprising:
a control member configured to be manipulated by a user;
a sensor coupled with the control member, wherein the sensor is configured to measure a force applied to the control member due to a manipulation by the user upon the control member;
an actuator configured to displace a portion of the system that is engaged by the user during system operation; and
a processor coupled with the sensor and the actuator, wherein the processor is configured with control process logic to:
receive signals from the sensor including information relating to forces applied to the control member by the user as measured by the sensor;
control movement of an object within an environment based upon the measured forces applied to the control member by the user; and
control the actuator to displace the portion of the system in response to a determination by the processor of a force being applied to the object within the environment.

2. The system of claim 1, wherein the processor is configured to control the actuator to displace the portion of the system in a direction by an amount that is proportional to the force being applied to the object within the environment.

3. The system of claim 1, wherein the processor is configured to control the actuator to displace the portion of the system in a motion pattern that imparts a series of vibrations to the portion of the system.

4. The system of claim 3, wherein the motion pattern applied to the portion of the system by the actuator changes in correspondence with a change in force applied to the object within the environment.

5. The system of claim 1, wherein the sensor outputs an electrical resistance value that changes depending upon an amount of force applied to the control member due to a manipulation by the user upon the control member.

6. The system of claim 1, wherein the actuator comprises at least one of a linear actuator that displaces a portion of the system in a linear direction and a rotary actuator that displaces a portion of the system in a rotational direction.

7. The system of claim 1, further comprising a computer system that includes the processor and a peripheral device that is coupled with the computer system and includes the control member, sensor and actuator.

8. The system of claim 7, wherein the computer system further includes a display that provides a visual image of controlled movements of the object in the environment.

9. The system of claim 8, wherein the control process logic of the processor is configured to control movement of a virtual object within a virtual environment.

10. The system of claim 7, wherein the control process logic of the processor is configured to control movement of an object at a location remote from the computer system.

11. The system of claim 1, wherein the system includes at least one of a plurality of control members, a plurality of actuators and a plurality of sensors to facilitate a plurality of degrees of freedom of movement of one or more body portions of the user while measuring forces applied to one or more control members based upon movements by the one or more body portions of the user.

12. A method for providing kinetic feedback within a system to facilitate computer-human interaction, the system including a control member configured to be manipulated by a user, a sensor coupled with the control member, an actuator configured to displace a portion of the system that is engaged by the user, and a processor coupled with the sensor and the actuator, the method comprising:
measuring forces applied to the control member, utilizing the sensor, due to a manipulation by the user upon the control member;
providing signals from the sensor to the processor that indicate forces applied to the control member by the user as measured by the sensor;
controlling movement of an object within an environment utilizing the processor, wherein the controlled movements are based upon the measured forces applied to the control member by the user; and
controlling the actuator, utilizing the processor, to displace the portion of the system in response to a determination by the processor of a force being applied to the object within the environment.

13. The method of claim 12, wherein the processor controls the actuator to displace the portion of the system in a direction by an amount that is proportional to the force being applied to the object within the environment.

14. The method of claim 12, wherein the processor controls the actuator to displace the portion of the system in a motion pattern that imparts a series of vibrations to the portion of the system.

15. The method of claim 14, wherein the motion pattern applied to the portion of the system by the actuator changes in correspondence with a change in force applied to the object within the environment.

16. The method of claim 14, wherein the sensor outputs an electrical resistance value that changes depending upon an amount of force applied to the control member due to a manipulation by the user upon the control member.

17. The method of claim 12, wherein the actuator comprises at least one of a linear actuator that displaces a portion of the system in a linear direction and a rotary actuator that displaces a portion of the system in a rotational direction.

18. The method of claim 12, wherein the processor is implemented within a computer system and the control member, sensor and actuator are implemented with a peripheral device that is coupled with the computer system.

19. The method of claim 18, wherein the computer system includes a display, and the method further comprises:
providing a visual image of controlled movements of the object in the environment.

20. The method of claim 19, wherein the processor controls movement of a virtual object within a virtual environment.

21. The method of claim 18, wherein the processor controls movement of an object at a location remote from the computer system.
